(19) United States
(12) Patent Application Publication
(10) Pub. No.: US 2026/0110422 A1
(43) Pub. Date: Apr. 23, 2026

(54) DETACHABLE FAN LAMP CONVENIENT FOR PACKAGING AND TRANSPORTATION

(71) Applicant: Fandelier Inc., Frisco, TX (US)

(72) Inventor: Bobo YAO, Zhejiang (CN)

(21) Appl. No.: 19/371,136

(22) Filed: Oct. 28, 2025

(51) Int. Cl. F21V 19/00; F21V 21/03

(52) U.S. Cl. CPC F21V 19/0075; F21V 21/03

(57) ABSTRACT

A detachable fan lamp convenient for packaging and transportation, including a ceiling base, a fan arranged on the ceiling base, a plurality of connecting rods connected to the ceiling base, and a light-emitting portion connected to extending ends of the connecting rods. The light-emitting portion includes a plurality of lamp rings connected end to end, lamp bodies arranged inside the lamp rings, and connecting members configured to connect two adjacent lamp rings. Both the lamp rings and the connecting members have a circular cross-section. Each connecting member is internally hollow to form a through hole, and both a first end and a second end of two adjacent lamp rings are fixed inside the through hole. This segmented design of the lamp rings facilitates packaging and transportation.

### TECHNICAL FIELD

The present disclosure relates to the technical field of fan lamps, and in particular, to a detachable fan lamp convenient for packaging and transportation.

### BACKGROUND

With the development of smart homes, fan lamps are widely used in households, offices, and other scenarios due to their dual functions of lighting and ventilation. Conventional fan lamps typically feature an integrally molded lamp ring structure, which results in a relatively large volume of the lamp ring. This necessitates larger packaging dimensions, increasing the risk of deformation or damage during transportation due to collisions and raising transportation costs. To address the above issues, existing fan lamps generally separate the lamp ring and the lamp frame into multiple parts for delivery. However, this requires users to first assemble the lamp frame and then install the lamp rings one by one onto the corresponding lamp frame during assembly, making the installation process of the fan lamp relatively cumbersome.

### SUMMARY

In view of the above, the present disclosure provides a detachable fan lamp that is convenient for packaging, transportation, and assembly.

The present disclosure provides a detachable fan lamp, including a ceiling base configured to be fixed to a wall, a fan arranged on the ceiling base, a plurality of connecting rods connected to the ceiling base, and a light-emitting portion connected to extending ends of the plurality of connecting rods, where the light-emitting portion includes a plurality of lamp rings connected end to end, a lamp body arranged inside the plurality of lamp rings, and a connecting member configured to connect two adjacent lamp rings, where both the plurality of lamp rings and the connecting member have a circular cross-section, the connecting member is internally hollow to form a through hole, and both a first end and a second end of two adjacent lamp rings are fixed inside the through hole.

In some implementations of the present disclosure, each of the plurality of lamp rings includes an upper housing and a lower housing connected to the upper housing, a first groove is provided on a lower side of the upper housing, a second groove is provided on an upper side of the lower housing, and the first groove and the second groove are combined to form a cavity for assembling the lamp body, where the lower housing is made of a light-transmitting material.

In some implementations of the present disclosure, a first opening is provided on a side wall of the first groove near both ends of the upper housing to connect the cavity with the through hole, a second opening is provided on a side wall of the second groove near both ends of the lower housing to connect the cavity with the through hole, and the first opening and the second opening are combined to form a wire lead-through hole for passing a power cord of the lamp body.

In some implementations of the present disclosure, a shape of an upper base surface of the first opening and a shape of a lower base surface of the second opening are both serrated.

In some implementations of the present disclosure, a positioning groove is provided on an upper side of the lower housing, and a positioning rib configured to engage with the positioning groove is provided on a lower side of the upper housing.

In some implementations of the present disclosure, a snap-fit structure and/or a threaded connection structure is provided between the upper housing and the lower housing to connect the upper housing and the lower housing.

In some implementations of the present disclosure, the snap-fit structure includes a plurality of snaps provided on a lower side of the upper housing, and a plurality of snap grooves provided on an upper side of the lower housing and configured to engage with the plurality of snaps.

In some implementations of the present disclosure, the threaded connection structure includes first threaded holes provided at both ends of the upper housing, second threaded holes provided at both ends of the lower housing, and first screws passing through the first threaded holes and fastened into the second threaded holes.

In some implementations of the present disclosure, the connecting rods are internally hollow to form wire routing channels connecting the through holes with an interior of the ceiling base, and a gap is formed between a first end and a second end of two adjacent lamp rings.

In some implementations of the present disclosure, the connecting member includes a connection portion provided on an upper side thereof and configured to connect with the plurality of connecting rods, a connection groove is provided on an upper side of the connection portion, an abutting rib configured to abut against a bottom surface of the connection groove is provided at an extending end of the connecting rod, a through hole communicating with the wire routing channel is provided on the connection portion at the connection groove, a third threaded hole is provided on the abutting rib, a fourth threaded hole communicating with the third threaded hole is provided on the connection portion, a fifth threaded hole communicating with the fourth threaded hole is provided on the lamp ring, and second screws are provided in the third threaded hole, the fourth threaded hole, and the fifth threaded hole to connect the third threaded hole, the fourth threaded hole, and the fifth threaded hole.

The fan lamp provided by the present disclosure includes a ceiling base, a fan, connecting rods, and a light-emitting portion. The light-emitting portion includes a plurality of lamp rings connected end to end, lamp bodies arranged inside the lamp rings, and connecting members configured to connect two adjacent lamp rings. Both the lamp rings and the connecting members have a circular cross-section. Each connecting member is internally hollow to form a through hole, and both a first end and a second end of two adjacent lamp rings are fixed inside the through hole. This segmented design of the lamp rings facilitates packaging and transportation. Additionally, both the lamp rings and the connecting members have a circular cross-section, which allows users to easily insert the lamp rings into the connecting members for connection. Meanwhile, the lamp bodies are arranged inside the lamp rings and integrated with the lamp rings as a unitary structure, thereby reducing the installation steps between the lamp bodies and the lamp rings and facilitating the assembly of the fan lamp.

### BRIEF DESCRIPTION OF THE DRAWINGS

FIG. 1 is an assembly schematic view of the present disclosure;

FIG. 2 is a schematic view of the present disclosure;

FIG. 3 is an assembly schematic view of the light-emitting portion and the connecting rod of the present disclosure;

FIG. 4 is an assembly schematic view of the light-emitting portion of the present disclosure;

FIG. 5 is a schematic view of the upper housing of the present disclosure;

FIG. 6 is a schematic view of the lower housing of the present disclosure;

FIG. 7 is a schematic view of the connecting member of the present disclosure;

FIG. 8 is a schematic view of the connecting rod of the present disclosure.

### DETAILED DESCRIPTION

The technical solutions in the embodiments of the present disclosure will be hereinafter clearly and completely described in combination with the accompanying drawings.

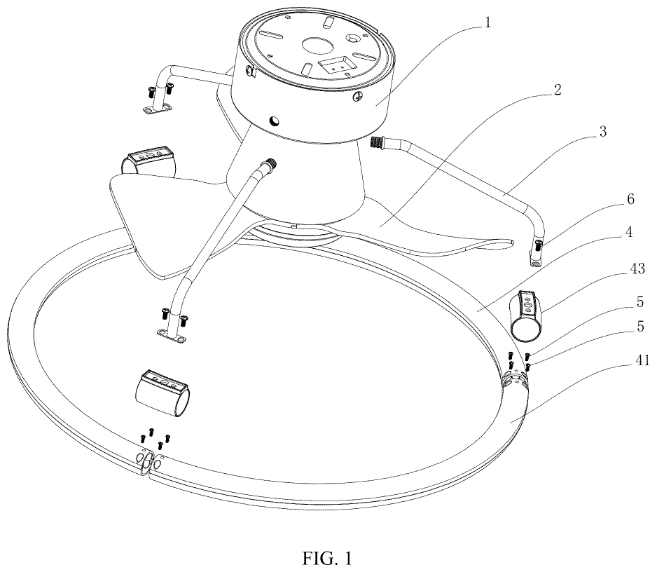

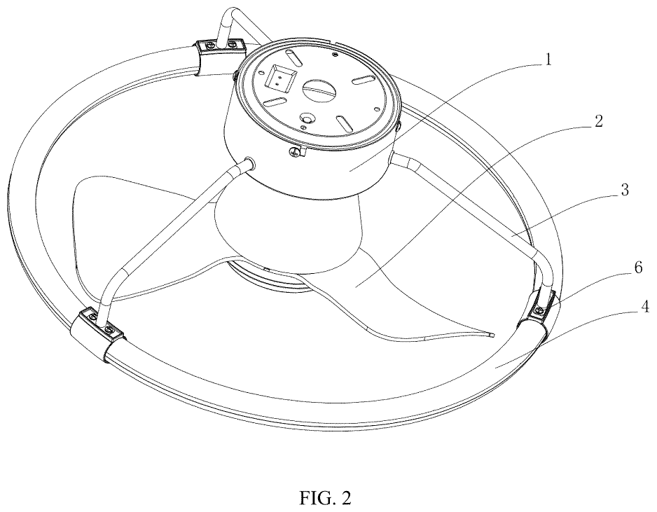

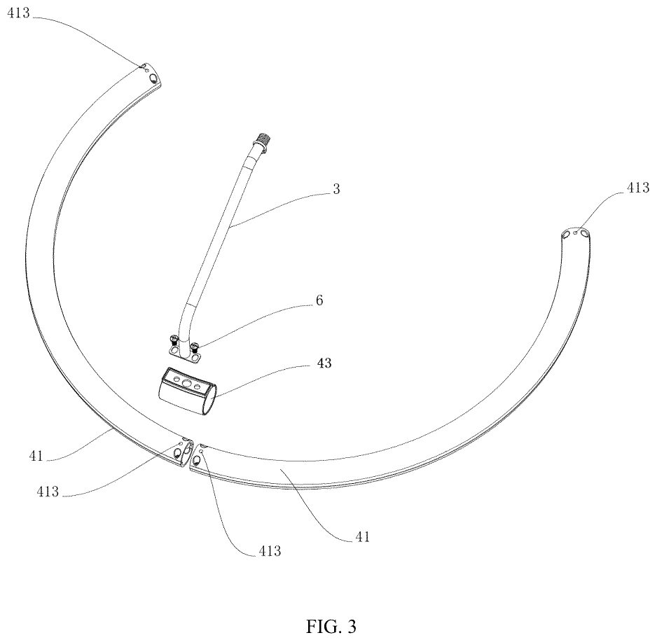

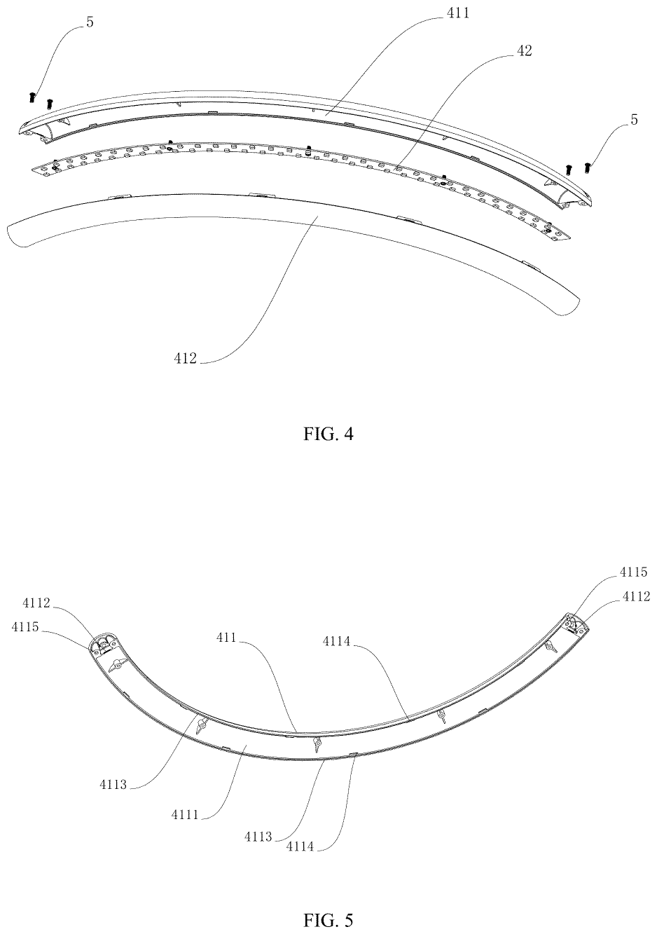

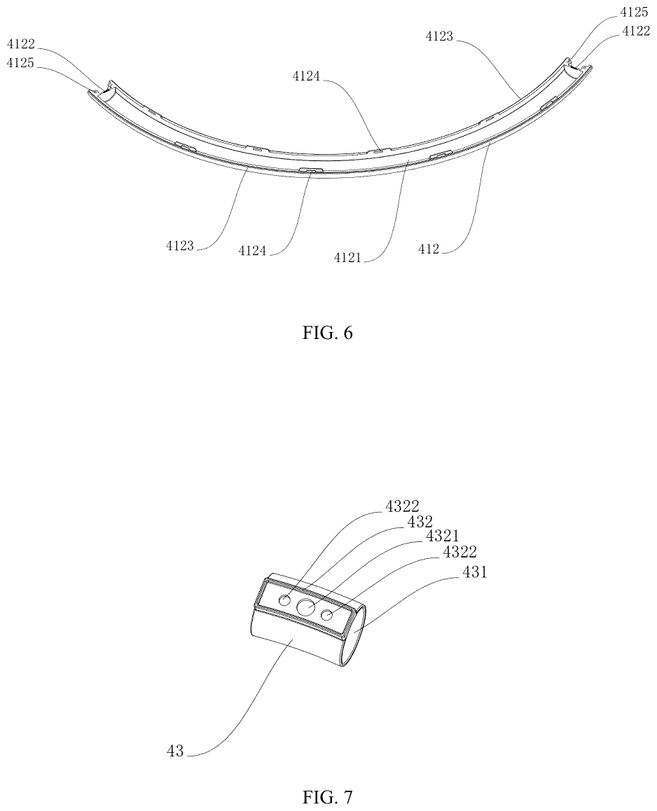

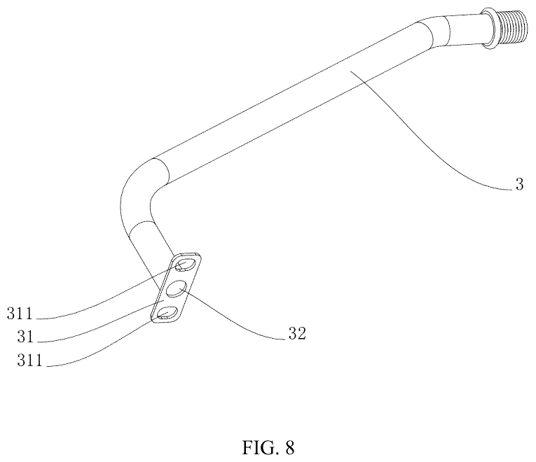

With reference to FIGS. 1 to 8, a detachable fan lamp convenient for packaging and transportation includes a ceiling base 1 configured to be fixed to a wall, a fan 2 arranged on the ceiling base 1, a plurality of connecting rods 3 connected to the ceiling base 1, and a light-emitting portion 4 connected to extending ends of the plurality of connecting rods 3. The light-emitting portion 4 includes a plurality of lamp rings 41 connected end to end, lamp bodies 42 arranged inside the lamp rings 41, and connecting members 43 configured to connect two adjacent lamp rings 41. Both the lamp rings 41 and the connecting members 43 have a circular cross-section (vertical section passing through the center), and each connecting member 43 is internally hollow to form a through hole 431. Both a first end and a second end of two adjacent lamp rings 41 are fixed inside the through hole 431. This segmented design of the plurality of lamp rings 41, combined with detachable connections achieved through the connecting members 43, allows the plurality of lamp rings 41 to be disassembled for packaging during transportation, significantly reducing packaging volume and lowering transportation costs. Additionally, it reduces the risk of collision damage during transportation and enhances product transportation safety. Furthermore, both the plurality of lamp rings 41 and the connecting members 43 have a circular cross-section, enabling users to easily insert the plurality of lamp rings 41 into the connecting members 43 for connection. Meanwhile, the lamp bodies 42 are arranged inside the lamp rings 41 and integrated with the plurality of lamp rings 41 as a single structure, thereby reducing the installation steps between the lamp bodies 42 and the lamp rings 41 and facilitating the assembly of the fan lamp.

In the present solution, the lamp ring 41 includes an upper housing 411 and a lower housing 412 connected to the upper housing 411. A first groove 4111 is provided on a lower side of the upper housing 411, and a second groove 4121 is provided on an upper side of the lower housing 412. The first groove 4111 and the second groove 4121 are combined to form a cavity for assembling the lamp body 42. The lower housing 412 is made of a light-transmitting material (acrylic). The lamp body 42 includes a circuit board fixed to the upper housing 411 and a plurality of lamp beads arranged on the circuit board. Thus, the lamp body 42 is arranged inside the lamp ring 41, and the cavity is substantially sealed, providing certain waterproof and dustproof functions.

In the present solution, a first opening 4112 is provided on a side wall of the first groove 4111 near both ends of the upper housing 411 to connect the cavity with the through hole 431. A second opening 4122 is provided on a side wall of the second groove 4121 near both ends of the lower housing 412 to connect the cavity with the through hole 431. The first opening 4112 and the second opening 4122 are combined to form a wire lead-through hole for passing a power cord of the lamp body 42. Furthermore, a shape of an upper base surface of the first opening 4112 and a shape of a lower base surface of the second opening 4122 are both serrated. This facilitates wiring and also prevents the power cord from loosening.

In the present solution, a positioning groove 4123 is provided on an upper side of the lower housing 412, and a positioning rib 4113 configured to engage with the positioning groove 4123 is provided on a lower side of the upper housing 411. This allows the upper housing 411 and the lower housing 412 to achieve rapid alignment through the positioning groove 4123 and the positioning rib 4113, facilitating their connection.

In the present solution, a snap-fit structure and/or a threaded connection structure is provided between the upper housing 411 and the lower housing 412 to connect the upper housing 411 and the lower housing 412. Specifically, the snap-fit structure includes a plurality of snaps 4114 provided on a lower side of the upper housing 411, and a plurality of snap grooves 4124 provided on an upper side of the lower housing 412 and configured to engage with the plurality of snaps 4114. The threaded connection structure includes first threaded holes 4115 provided at both ends of the upper housing 411, second threaded holes 4125 provided at both ends of the lower housing 412, and first screws 5 passing through the first threaded holes 4115 and fastened into the second threaded holes 4125. This arrangement allows for preliminary fixation through the snap-fit structure, followed by reinforcement via the threaded connection structure, ensuring a secure connection between the upper housing 411 and the lower housing 412.

In the present solution, the connecting rods 3 are internally hollow to form wire routing channels 32 connecting the through holes 431 with an interior of the ceiling base 1. A gap is provided between a first end and a second end of two adjacent lamp rings 41, and the gap communicates with an outlet below the wire routing channels 32. This design enables the power cords of different lamp bodies 42 to be connected in series and then linked to an adapter inside the ceiling base 1 for power supply, resulting in a more rational wiring layout.

In the present solution, the connecting member 43 includes a connection portion 432 provided on an upper side thereof and configured to connect with the connecting rods 3. A connection groove 433 is provided on an upper side of the connection portion 432. An abutting rib 31 configured to abut against a bottom surface of the connection groove 433 is provided at an extending end of the connecting rod 3. A third threaded hole 311 is provided on the abutting rib 31, and a fourth threaded hole 4322 communicating with the third threaded hole 311 is provided on the connection portion 432. A fifth threaded hole 413 communicating with the fourth threaded hole 4322 is provided on the lamp ring 41. A through hole 4321 communicating with the wire routing channel 4311 is provided on the connection portion 432 at the connection groove 433. Second screws 6 are provided in the third threaded hole 311, the fourth threaded hole 4322, and the fifth threaded hole 413 to connect them. This configuration achieves the connection between the connecting rods 3 and the connecting member 43, and the design of the connection groove 433 facilitates the secure fixation of the connecting rods 3 to the connecting member 43.

Inspired by the ideal embodiments of the present disclosure described above, and based on the foregoing description, relevant personnel may make various modifications and changes without departing from the technical spirit of the present disclosure. The technical scope of the present disclosure is not limited to the content of the specification but should be determined based on the scope of the claims.

What is claimed is:

1. A detachable fan lamp, comprising a ceiling base configured to be fixed to a wall, a fan arranged on the ceiling base, a plurality of connecting rods connected to the ceiling base, and a light-emitting portion connected to extending ends of the plurality of connecting rods, wherein the light-emitting portion comprises a plurality of lamp rings connected end to end, a lamp body arranged inside the plurality of lamp rings, and a connecting member configured to connect two adjacent lamp rings, wherein both the plurality of lamp rings and the connecting member have a circular cross-section, the connecting member is internally hollow to form a through hole, and both a first end and a second end of two adjacent lamp rings are fixed inside the through hole.

2. The detachable fan lamp according to claim 1, wherein each of the plurality of lamp rings comprises an upper housing and a lower housing connected to the upper housing, a first groove is provided on a lower side of the upper housing, a second groove is provided on an upper side of the lower housing, and the first groove and the second groove are combined to form a cavity for assembling the lamp body, wherein the lower housing is made of a light-transmitting material.

3. The detachable fan lamp according to claim 2, wherein a first opening is provided on a side wall of the first groove near both ends of the upper housing to connect the cavity with the through hole, a second opening is provided on a side wall of the second groove near both ends of the lower housing to connect the cavity with the through hole, and the first opening and the second opening are combined to form a wire lead-through hole for passing a power cord of the lamp body.

4. The detachable fan lamp according to claim 3, wherein a shape of an upper base surface of the first opening and a shape of a lower base surface of the second opening are both serrated.

5. The detachable fan lamp according to claim 2, wherein a positioning groove is provided on an upper side of the lower housing, and a positioning rib configured to engage with the positioning groove is provided on a lower side of the upper housing.

6. The detachable fan lamp according to claim 5, wherein a snap-fit structure and/or a threaded connection structure is provided between the upper housing and the lower housing to connect the upper housing and the lower housing.

7. The detachable fan lamp according to claim 6, wherein the snap-fit structure comprises a plurality of snaps provided on a lower side of the upper housing, and a plurality of snap grooves provided on an upper side of the lower housing and configured to engage with the plurality of snaps.

8. The detachable fan lamp according to claim 6, wherein the threaded connection structure comprises first threaded holes provided at both ends of the upper housing, second threaded holes provided at both ends of the lower housing, and first screws passing through the first threaded holes and fastened into the second threaded holes.

9. The detachable fan lamp according to claim 1, wherein the connecting rods are internally hollow to form wire routing channels connecting the through holes with an interior of the ceiling base, and a gap is formed between a first end and a second end of two adjacent lamp rings.

10. The detachable fan lamp according to claim 9, wherein the connecting member comprises a connection portion provided on an upper side thereof and configured to connect with the plurality of connecting rods, a connection groove is provided on an upper side of the connection portion, an abutting rib configured to abut against a bottom surface of the connection groove is provided at an extending end of the connecting rod, a through hole communicating with the wire routing channel is provided on the connection portion at the connection groove, a third threaded hole is provided on the abutting rib, a fourth threaded hole communicating with the third threaded hole is provided on the connection portion, a fifth threaded hole communicating with the fourth threaded hole is provided on the lamp ring, and second screws are provided in the third threaded hole, the fourth threaded hole, and the fifth threaded hole to connect the third threaded hole, the fourth threaded hole, and the fifth threaded hole.
